(19) United States
(12) Patent Application Publication
(10) Pub. No.: US 2008/0050111 A1
(43) Pub. Date: Feb. 28, 2008

(54) Apparatus and method for setting camera values in mobile terminal

(75) Inventors: Chang Young Lee, Gumi-si (KR); Jae Wan Park, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/655,254

(22) Filed: Jan. 19, 2007

(30) Foreign Application Priority Data
Aug. 22, 2006 (JP) 2006-0079397

(51) Int. Cl. G03B 19/00

(52) U.S. Cl. 396/429

(57) ABSTRACT

Provided is an apparatus and a method for setting a camera in a mobile terminal with camera-setting values of photographing parameters. The method includes identifying a current time and a location of the mobile terminal; transmitting location information of the mobile terminal to a weather information providing server and receiving weather information from the weather information providing server corresponding to the location information; retrieving camera-setting values of photographing parameters from a storage unit according to the time and weather information; and setting a camera with the camera-setting values. Accordingly, photography is made more user friendly for a user unskilled with a camera and high-quality photographs are achieved by automatically modifying the photographing parameters of a camera installed in a mobile terminal according to a season, weather, and time.

### CROSS-REFERENCE TO RELATED APPLICATION

This application claims the benefit under 35 U.S.C. §119(a) to an application entitled “Apparatus And Method For Setting Camera In Mobile Terminal” filed in the Korean Intellectual Property Office on Aug. 22, 2006 and assigned Serial No. 2006-0079397, the entire disclosure of which is hereby incorporated by reference.

### BACKGROUND OF THE INVENTION

1. Field of the Invention

The present invention relates to a mobile terminal. More particularly, the present invention relates to an apparatus and a method for setting photographing parameters of a camera installed in a mobile terminal with optimum values that are automatically modified depending on environmental factors.

2. Description of the Prior Art

As a result of the development of manufacturing technologies for mobile terminals, mobile phones and personal digital assistants (PDA) have gained in popularity.

According to various users' requirements, mobile terminals have been developed to support additional functions, such as wireless Internet, MP3 player, and camera, in addition to their basic function of telephone communications. Among the additional functions, a typical example is taking a picture with a camera installed in a mobile terminal.

The camera installed in a mobile terminal is very sensitive to the external environment, particularly to light conditions. Unskilled camera users generally are not able to compensate for the environmental factors correctly. To perform picture compensation, automatic cameras and cameras installed in mobile terminals provide basic camera-setting values for photographing parameters such as exposure, zoom, and resolution, and the users may take a picture by simply pressing a shutter button without changing camera-setting values in a camera mode of the mobile terminal.

However, the camera-setting values are not optimized according to environmental factors, but instead use average values calculated from allowable maximum and minimum values. In very strong sunlight or in a very dark environment, camera users themselves must modify the camera-setting values. Unskilled camera users may face difficulties in changing the camera-setting values, and may have undesired results such as over-exposed and under-exposed photographs.

Accordingly, there is a need for an improved apparatus and a method for automatically modifying camera-setting values that correspond to time, weather, and season of an area in which the mobile terminal is located, to improve the quality of photographs.

### SUMMARY OF THE INVENTION

Exemplary embodiments of the present invention address at least the above problems and/or disadvantages and provide at least the advantages described below. Accordingly, an aspect of an exemplary embodiment of the present invention is to provide an apparatus and a method for automatically modifying camera-setting values of photographing parameters corresponding to time, weather, and season of an area in which the mobile terminal is located, to improve the quality of photographs.

Another aspect of an exemplary embodiment of the present invention is to provide an apparatus and a method enabling unskilled camera users to take an improved photograph by automatically modifying the camera setting values of a camera installed in a mobile terminal corresponding to time, weather, and season.

Another aspect of an exemplary embodiment of the present invention is to provide an apparatus and a method enabling camera users to modify the camera-setting values of a camera installed in a mobile terminal and to apply the modified settings to the camera.

Yet another aspect of an exemplary embodiment of the present invention is a photographing method in a mobile terminal that includes identifying a current time and a location of the mobile terminal; transmitting location information of the mobile terminal to a weather information providing server and receiving weather information from the weather information providing server corresponding to the location information; retrieving camera-setting values of photographing parameters from a storage unit according to the time and weather information; and setting a camera with the camera-setting values.

A further aspect of an exemplary embodiment of the present invention is a mobile terminal installed with a camera that includes a season identifier for identifying a season by using time and location information of the mobile terminal; a communication unit for transmitting the time and location information to a server and receiving weather information from the server; a storage unit for storing camera-setting values of photographing parameters corresponding to the season, weather, and time information; a camera-setting value retriever for retrieving, from the storage unit, the camera-setting values corresponding to the season, weather, and time information; a control unit for setting a camera with the retrieved camera-setting values; a camera for taking a picture by using the camera-setting values; and a display unit for displaying a photograph taken by the camera.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram showing a configuration of a mobile terminal according to an exemplary embodiment of the present invention;

FIGS. 2A and 2B are flow charts showing operating methods of a mobile terminal according to exemplary embodiments of the present invention; and

FIG. 3 is a view showing exemplary screens in the operation of a mobile terminal according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

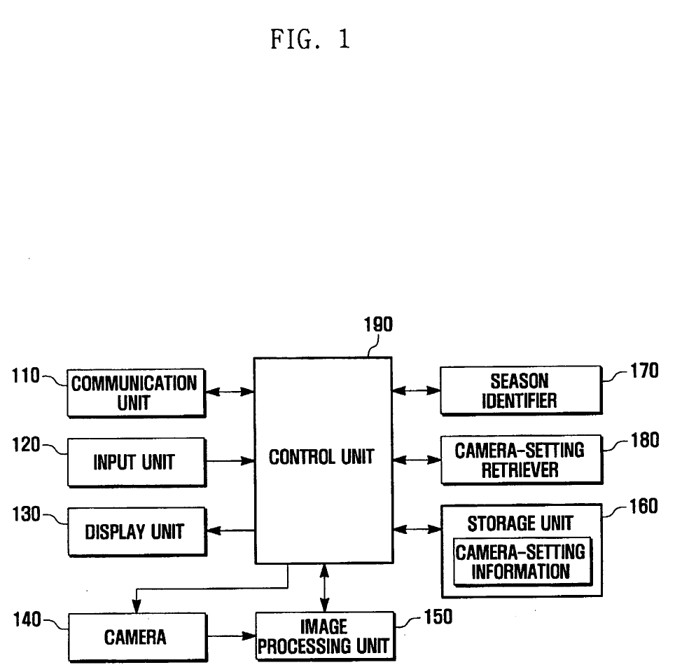

FIG. 1 is a block diagram showing a configuration of a mobile terminal according to an exemplary embodiment of the present invention. Referring to FIG. 1, the mobile terminal includes a communication unit 110, input unit 120, display unit 130, camera 140, image processing unit 150, storage unit 160, season identifier 170, camera-setting retriever 180, and control unit 190.

The communication unit 110 may include an RF transmitter for amplifying and upconverting the frequency of signals to be transmitted, and an RF receiver for low-noise amplifying and downconverting the frequency of received signals. The communication unit 110 performs data communication for the mobile terminal by using a wireless network.

Particularly, in exemplary embodiments of the present invention, the communication unit 110 receives time and location information of the mobile terminal from a base station through a wireless network. The mobile terminal transmits the location information to a weather information providing server and receives weather information corresponding to the location information of the mobile terminal.

The input unit 120 may be formed with a touch screen or a keypad having alphanumeric keys, function keys, and special keys. The input unit 120 transmits signals input by a user for the control of the mobile terminal to the control unit 190. The input unit 120 is used to input camera-setting values of photographing parameters and a selection signal for photographing.

The display unit 130 may be formed with a liquid crystal display (LCD), and displays various data generated by the mobile terminal and the current operating status of the mobile terminal. Additionally, the display unit 130 receives, in real time, image data from the image processing unit 150, and displays a preview image of the received data.

The camera 140 takes a picture, and includes a camera sensor for converting light into an electric signal (analog image signal) and a signal processing unit for converting the analog image signal into digital data. Generally, a CCD (charge coupled device) is used as a camera sensor, and the signal processing unit utilizes a DSP (digital signal processor). In exemplary embodiments of the present invention, the camera 140 takes a picture by using camera-setting values of photographing parameters.

The image processing unit 150 generates screen data to display image signals output by the camera 140. The image processing unit 150 processes the image data output by the camera 140 in a frame unit, and outputs the frame image data corresponding to the display characteristics and size of the display unit 130. Additionally, the image processing unit 150 is installed with an image codec, and compresses the frame image data displayed on the display unit 130 or decompresses the compressed frame image data back into the initial frame image data. The image codec may be one of a JPEG codec, MPEG codec, and Wavelet codec. However, as will be readily apparent, any suitable image codec may be used.

The storage unit 160 stores programs for general operation of the mobile terminal and data (particularly, camera-setting information including photographing parameters and their values corresponding to time and weather). The storage unit 160 stores the camera-setting values corresponding to the time and weather in a database as exemplified in Table 1.

TABLE 1

| | | | | Exposure | | |
|---|---|---|---|---|---|---|
| | | | | | | Shutter |
| Season | Weather | Time period | Flash | ISO | Aperture | speed |
| Spring | . . . | . . . | . . . | . . . | . . . | . . . |
| Summer | Clear | 20:00–05:00 | on | 1600 | F1.2 | 1/150 sec |
| | | 05:00–08:00 | on | 200 | F1.4 | 1/200 sec |
| | | 08:00–15:00 | off | 100 | F2.8 | 1/500 sec |
| | | 15:00–20:00 | on | 400 | F2.0 | 1/150 sec |
| | Cloudy | 20:00–05:00 | on | 1600 | F1.2 | 1/150 sec |
| | | 05:00–08:00 | on | 200 | F1.4 | 1/200 sec |
| | | 08:00–15:00 | off | 400 | F2.8 | 1/200 sec |
| | | 15:00–20:00 | on | 800 | F2.0 | 1/150 sec |
| | Rainy | 20:00–05:00 | on | 1600 | F1.2 | 1/150 sec |
| | | 05:00–08:00 | on | 400 | F1.4 | 1/200 sec |
| | | 08:00–15:00 | on | 400 | F1.4 | 1/200 sec |
| | | 15:00–20:00 | on | 800 | F1.2 | 1/150 sec |
| Autumn | . . . | . . . | . . . | . . . | . . . | . . . |
| Winter | Snowy | 20:00–05:00 | on | 1600 | F1.2 | 1/150 sec |
| | | 05:00–08:00 | on | 400 | F1.4 | 1/200 sec |
| | | 08:00–15:00 | on | 100 | F2.8 | 1/200 sec |
| | | 15:00–20:00 | on | 800 | F2.0 | 1/150 sec |
| | . . . | . . . | . . . | . . . | . . . | . . . |

The camera-setting information shown in Table 1 includes environmental factors influencing the quality of photos, such as season, weather, and the time period. The camera-setting information further includes photographing parameters such as use of a flash, ISO (International Organization Standardization) sensitivity, aperture, and shutter speed. As shown in Table 1, the photographing parameters have several values themselves and many combinations thereof according to the environmental factors.

The mobile terminal may identify the season, time, and location of a location of the mobile terminal, by receiving time and location information from a base station. Additionally, the mobile terminal receives weather information corresponding to the location of the mobile terminal from a weather information providing server; retrieves optimum values of photographing parameters corresponding to the season, weather, and time from the database shown in Table 1; and sets the camera of the mobile terminal with the retrieved values accordingly.

The season identifier 170 identifies a season for an area in which the mobile terminal is located, by using the year/month/day information included in the time and location information received from the base station.

The camera-setting retriever 180 retrieves optimum values of photographing parameters from the camera-setting information stored in the storage unit 160. The retrieved values depend on the weather information received from the weather information providing server, the season information received from the season identifier 170, and the time information received from the base station.

The control unit 190 controls the general operation of the mobile terminal. In particular, the control unit 190 controls the communication unit 110 to transmit the time and location information received from the base station to the weather information providing server. Additionally, the control unit 190 controls the display unit 130 to preview a subject on a screen by applying the optimum values of the photographing parameters retrieved from the camera-setting retriever 180. The control unit 190 sets the camera 140 with the retrieved values or modifies the setting values of the camera 140 according to information input by the user.

Although an exemplary embodiment of identifying the current location of the mobile terminal by using a base station has been disclosed, exemplary embodiments of the present invention are not limited thereto. The present invention may include another exemplary embodiment of identifying the current location of the mobile terminal by using signals received from GPS (Global Positioning Service) satellites. In this case, the mobile terminal preferably includes a GPS receiver.

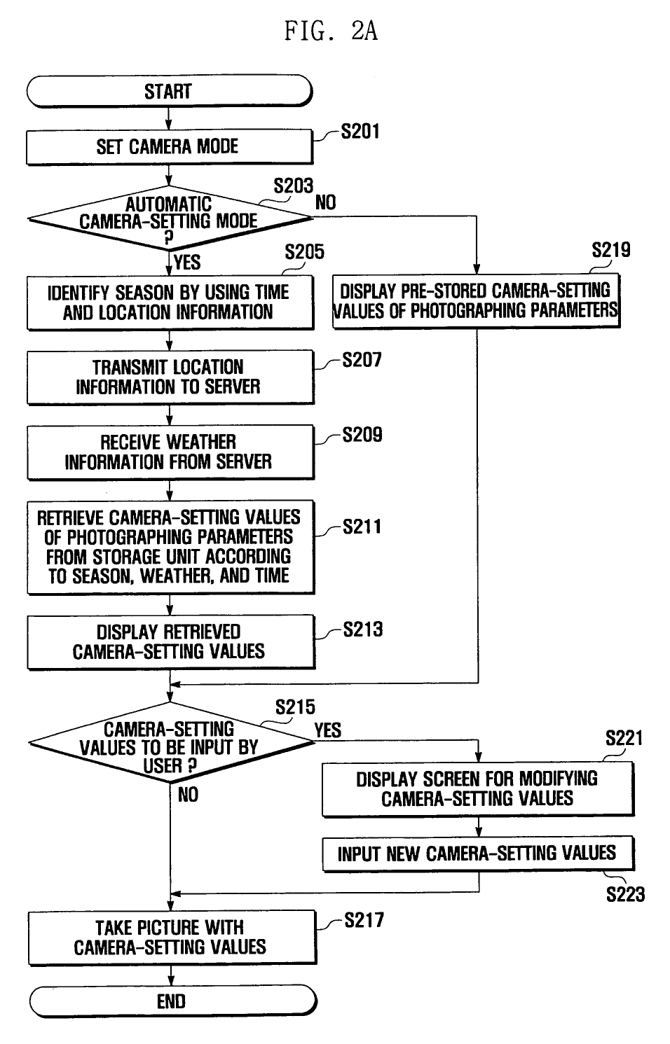

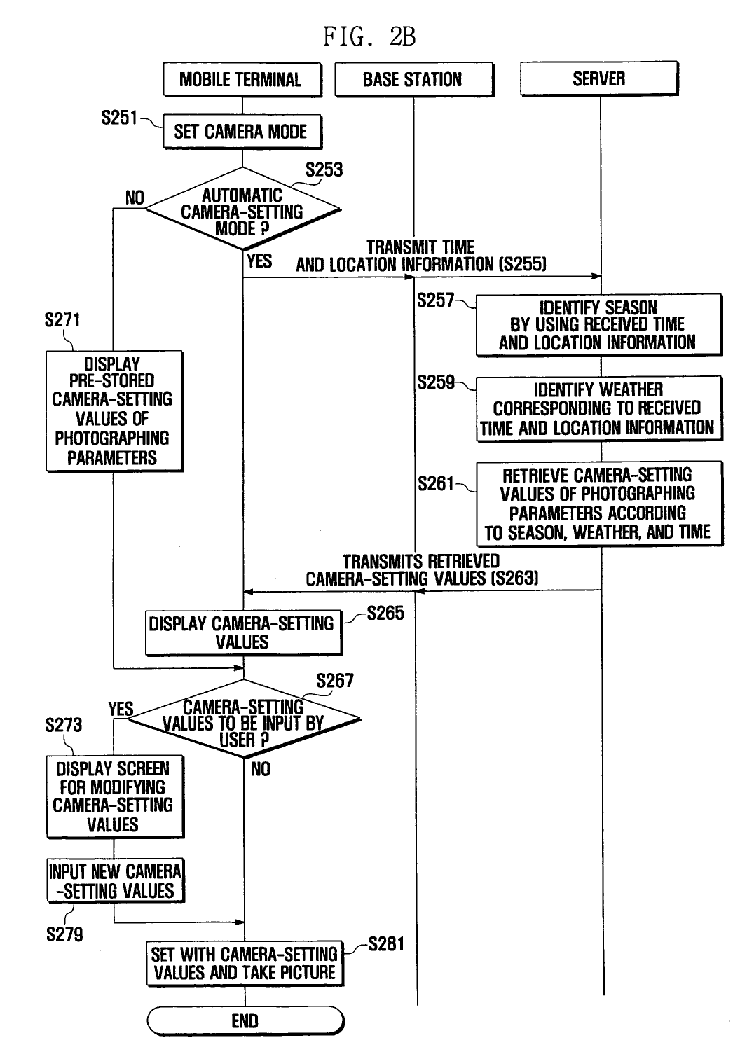

FIGS. 2A and 2B are flow charts showing operating methods of a mobile terminal according to exemplary embodiments of the present invention. FIG. 2A is a flow chart showing operational steps of a mobile terminal installed with a camera and having camera-setting information.

Referring to FIG. 2A, the mobile terminal is set in a camera mode (S201).

The mobile terminal identifies whether the mobile terminal is currently in an automatic camera-setting mode (S203).

The camera-setting includes at least one camera-setting value of at least one photographing parameter influencing the quality of photographs, such as use of a flash as an auxiliary illumination device, ISO sensitivity indicating sensitivity to light, aperture for controlling the amount of light passing through a lens, and shutter speed indicating a duration of an aperture opening. The automatic camera-setting mode allows for automatically setting (i.e., selecting and determining) at least one optimum value of at least one photographing parameter according to time, weather, and season of an area in which the mobile terminal is located.

If the mobile terminal is not in an automatic camera-setting mode in the step S203, the mobile terminal displays pre-stored camera-setting values on the preview screen (S219), and then identifies whether there is a user's input for modifying camera-setting values (S215).

If the mobile terminal is in an automatic camera-setting mode in the step S203, the mobile terminal identifies a season by using time and location information received from a base station (S205).

The season may be identified by using year/month/day information included in the time and location information. For example, if the current time is ‘2006-08-03 14:00:20’, it is summer in Seoul and it is winter in Sydney.

After identifying the season, the mobile terminal transmits the location information to a weather information providing server through a wireless network (S207), and receives weather information from the weather information providing server corresponding to the transmitted location information (S209).

The mobile terminal retrieves optimum values of photographing parameters from the camera-setting information stored in the storage unit 160 according to the weather information received from the weather information providing server, the season information identified in the step S205, and the time information received from the base station (S211). The mobile terminal displays the retrieved camera-setting values on a preview screen (S213). The mobile terminal then identifies whether there is a user's input for modifying camera-setting values, namely, whether a signal is input for modifying the current values (S215).

If a signal is not input by the user in the step S215, the mobile terminal sets the camera with the current camera-setting values retrieved corresponding to the season, weather, and time information, and takes a picture (S217).

If a signal is be input by the user in the step S215, the mobile terminal displays a screen for modifying the current values on the display unit 130 (S221).

New camera-setting values for modifying the current camera-setting values are then input by the user (S223), and the mobile terminal sets the camera 140 with the modified values and takes a picture (S217).

FIG. 2B is a flow chart showing operational steps of camera-setting by downloading camera-setting values from an external server. Referring to FIG. 2B, the mobile terminal is set in a camera mode (S251).

The mobile terminal identifies whether the mobile terminal is currently in an automatic camera-setting mode (S253).

The camera-setting includes setting at least one camera-setting value of at least one photographing parameter influencing the quality of photographs, such as use of a flash as an auxiliary illumination device, ISO sensitivity indicating sensitivity to light, aperture for controlling the amount of light passing through a lens, and shutter speed indicating a duration of the aperture opening. The automatic camera-setting mode allows automatically setting (i.e., selecting and determining) at least one optimum value of at least one photographing parameter according to time, weather, and season of an area in which the mobile terminal is located.

If the mobile terminal is not in an automatic camera-settings mode, the mobile terminal displays pre-stored camera-setting values on the preview screen (S271) and then identifies whether there is a user's input for modifying camera setting values, namely, whether a signal is input for modifying the current values (S267).

If the mobile terminal is in an automatic camera-setting mode in the step S253, the mobile terminal transmits time and location information received from a base station to a server (S255).

The server provides weather information corresponding to the location information and camera-setting values corresponding to season, weather, and time information. The server identifies a season corresponding to the time and location information received from the mobile terminal (S257).

The server then identifies whether information corresponding to the location information received from the mobile terminal (S259), and retrieves camera-setting values stored in a storage unit according to the identified season and weather, and corresponding to the time information received from the base station (S261).

The server then transmits the retrieved optimum values of photographing parameters from camera-setting information to the mobile terminal (S263).

The mobile terminal displays the camera-setting values received from the server on a preview screen (S265).

The mobile terminal identifies whether there is a user's input for modifying camera setting values, namely, whether a signal is input for modifying the current values (S267). If a signal is not input by the user, the mobile terminal sets the camera 140 with the current values and takes a picture (S281).

If a signal is input by the user in the step S267, the mobile terminal displays a screen for modifying the current camera-setting values on the display unit 130 (S273). Subsequently, new camera-setting values for modifying the current camera-setting values are input by the user (S279), and the mobile terminal sets the camera 140 with the modified values and takes a picture (S281).

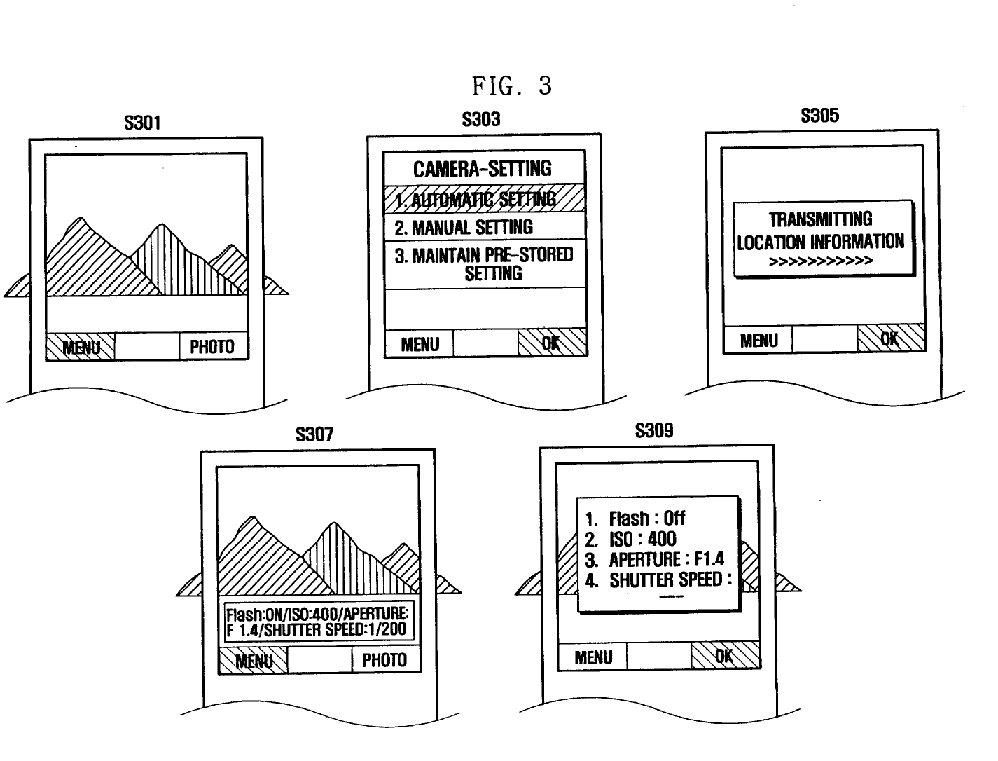

FIG. 3 is a view showing exemplary screens in an operation of a mobile terminal according to an exemplary embodiment of the present invention.

If a camera mode is selected, the mobile terminal displays a preview screen of a subject on the display unit 130 (S301).

If a ‘Menu’ button is selected, the mobile terminal displays a list of camera-setting methods on the display unit 130. The camera-setting method may include ‘Automatic setting’, ‘Manual setting’, and ‘Maintain pre-stored camera setting’ (S303).

If ‘Automatic setting’ is selected from the list, the mobile terminal receives the current location information (for example, ‘London, England’) from a base station and transmits the information to a weather information providing server through a wireless network (S305).

The mobile terminal receives weather information (for example, ‘Rainy’) from the weather information providing server corresponding to the location of the mobile terminal.

The mobile terminal receives time information (for example, ‘2006-08-14 14:00’) from a base station; identifies a season (for example, ‘Summer’) and time (for example, ‘14:00’) by using the time information; retrieves camera-setting values (for example, ‘Flash: ON, ISO sensitivity: 400, Aperture: F1.4, Shutter speed: 1/200 sec’) from a storage unit corresponding to the weather information (for example, ‘Rainy’) received from the weather information providing server.

The mobile terminal displays a preview screen of a subject on the display unit 130 by applying the retrieved camera-setting values. The mobile terminal preferably displays camera-setting values (for example, ‘Flash: ON, ISO sensitivity: 400, Aperture: F1.4, Shutter speed: 1/200 sec’) on the preview screen (S307).

The user may take a picture after confirming the preview screen or manually modify the camera-setting values displayed on the preview screen by selecting ‘Menu’ button (S309).

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

As described above, exemplary embodiments of the present invention enable an unskilled camera user to take an improved photograph by automatically modifying the setting of a camera installed in a mobile terminal. Additionally, the user may modify camera-setting values stored in a mobile terminal, and apply the modified camera-setting values to the camera.

While certain exemplary embodiments of the invention has have been shown and described herein with reference to a certain preferred embodiments thereof, it will be understood by those skilled in the art that various changes in form and details may be made therein without departing from the spirit and scope of the invention as defined by the appended claims and their equivalents.

What is claimed is:

1. A photographing method in a mobile terminal, comprising:
identifying a current time and a location of the mobile terminal;
transmitting location information of the mobile terminal to a weather information providing server and receiving weather information from the weather information providing server corresponding to the location information;
retrieving at least one camera-setting value of at least one photographing parameter from a storage unit according to the time and weather information; and
setting a camera with the at least one camera-setting value.

2. The photographing method of claim 1, wherein the at least one photographing parameter comprise at least one of activation or non-activation of a flash, ISO (International Organization for Standardization) sensitivity, aperture, or shutter speed.

3. The photographing method of claim 1, wherein the time and location information of the mobile terminal is received from a base station.

4. The photographing method of claim 1, wherein the location information of the mobile terminal is calculated by using signals received from GPS (Global Positioning Service) satellites.

5. The photographing method of claim 1, further comprising displaying the retrieved at least one camera-setting value on a display.

6. The photographing method of claim 1, further comprising identifying a season corresponding to the weather and time information, wherein the at least one camera-setting value is retrieved corresponding to the weather, time, and season information.

7. The photographing method of claim 5, further comprising setting the camera after modifying the at least one camera-setting value displayed on the screen.

8. A photographing method in a mobile terminal for setting a camera with at least one camera-setting value of at least one photographing parameter received from a server, comprising:
transmitting a current time and location information of the mobile terminal to the server;
transmitting the at least one camera-setting value to the mobile terminal from the server corresponding to the time and location information; and
setting a camera of the mobile terminal with the at least one camera-setting value received from the server.

9. The photographing method of claim 8, wherein the server provides at least one camera-setting value corresponding to weather, season, and time information.

10. The photographing method of claim 8, wherein transmitting the at least one camera-setting value to the mobile terminal comprises:
identifying a season by using the time and location information received from the mobile terminal;
identifying weather information by using the time and location information received from the mobile terminal;
retrieving the at least one camera-setting value from a storage unit corresponding to the weather, season, and time information; and
transmitting the retrieved at least one camera-setting value to the mobile terminal.

11. The photographing method of claim 8, further comprising displaying the retrieved at least one camera-setting value on a display.

12. The photographing method of claim 11, wherein displaying the retrieved at least one camera-setting value on the display further comprises setting the camera after modifying the at least one camera-setting value displayed on the screen.

13. A mobile terminal having a camera, comprising:
a season identifier for identifying a season by using time and location information of the mobile terminal;
a communication unit for transmitting the time and location information to a server and receiving weather information from the server;
a storage unit for storing at least one camera-setting value of at least one photographing parameter corresponding to the season, weather, and time information;
a camera-setting retriever for retrieving, from the storage unit, the at least one camera-setting value corresponding to the season, weather, and time information;
a control unit for setting a camera with the retrieved at least one camera-setting value;
a camera for taking a picture by using the at least one camera-setting value; and
a display unit for displaying a photograph taken by the camera.

14. The mobile terminal of claim 13, wherein the at least one photographing parameter comprise at least one of activation or non-activation of a flash, ISO (International Standardization for Organization) sensitivity, aperture, or shutter speed.

15. The mobile terminal of claim 13, wherein the time and location information on the mobile terminal is received from a base station.

16. The mobile terminal of claim 13, wherein the location information on the mobile terminal is calculated by using signals received from GPS (Global Positioning Service) satellites.

17. A computer-readable medium having embodied thereon a computer program for a photographing method in a mobile terminal, the method comprising:
identifying a current time and a location of the mobile terminal;
transmitting location information of the mobile terminal to a weather information providing server and receiving weather information from the weather information providing server corresponding to the location information;
retrieving at least one camera-setting value of at least one photographing parameter from a storage unit corresponding to the time and weather information; and
setting a camera with the at least one camera-setting value.

18. A computer-readable medium having embodied thereon a computer program for photographing method in a mobile terminal for setting a camera with at least one camera-setting value of at least one photographing parameter received from a server, the method comprising:
transmitting a current time and location information of the mobile terminal to the server;
transmitting at least one camera-setting value to the mobile terminal from the server corresponding to the time and location information; and setting a camera of the mobile terminal with the at least one camera-setting value received from the server.
